(19) United States
(12) Patent Application Publication
(10) Pub. No.: US 2016/0337548 A1
(43) Pub. Date: Nov. 17, 2016

(54) System and Method for Capturing and Sharing Content

(71) Applicants: Calvin Osborn, Ogden, UT (US); Jason Sullivan, Youngstown, OH (US)

(72) Inventors: Calvin Osborn, Ogden, UT (US); Jason Sullivan, Youngstown, OH (US)

(21) Appl. No.: 15/154,623

(22) Filed: May 13, 2016

Related U.S. Application Data
(60) Provisional application No. 62/185,400, filed on Jun. 26, 2015.
(60) Provisional application No. 62/161,720, filed on May 14, 2015.

(51) Int. Cl. H04N 1/32; H04N 1/21; G06F 17/30; H04N 1/00

(52) U.S. Cl. CPC H04N 1/32128; H04N 1/00244; H04N 1/2191; H04N 1/212; H04N 1/00251; G06F 17/30268; G06F 17/3082; H04N 2201/0084; H04N 2201/0044

(57) ABSTRACT

Systems and methods for capturing and sharing content are disclosed. Including capturing content data related to a scene via an image capturing device. Further including, capturing identifying data from a beacon via a sensor associated with the image capturing device wherein the identifying data identifies an artifact in the scene. Further including, binding the identifying data to the content data at the image capturing device such that the artifact may be subsequently identified in the content data. Further including, sending the identifying data and the content data, bound together, to a content server.

### RELATED APPLICATIONS

This application claims priority to co-pending U.S. Provisional Application No. 62/161,720, entitled “System and Method for Capturing and Sharing Digital Video Clips,” filed May 14, 2015, which is incorporated by reference in its entirety.

This application also claims priority to co-pending U.S. Provisional Application No. 62/185,400, entitled “System and Method for Capturing and Sharing Digital Video Clips,” filed Jun. 26, 2015, which is incorporated by reference in its entirety.

### BACKGROUND

1. Field of the Invention

The present invention relates generally to capturing and sharing content.

2. Related Art

As the number of mobile electronic devices with cameras increase, digital videography continues to increase in popularity. For example, see the GoPro video camera. Additionally, sharing images and video on social media has become more popular. With increased popularity, there is a proliferation of content and an increased desire to search for particular content.

### SUMMARY OF THE INVENTION

It has been recognized that it would be advantageous to develop a system and method to capture and share content. The invention includes techniques for capturing and sharing content in a way that makes the content easily searchable to users especially to users associated with the artifacts captured in the content. For example, in one aspect, a device captures content in a scene with an image capturing device while simultaneously capturing identifying data from a beacon via a sensor. The device then binds together the content and the identifying data. This data that is now bound together can be used to identify an artifact in an image of the content including the identity of a person in the image. The bound together data can also be used to create tags that are text searchable identifying the artifacts in the image.

### BRIEF DESCRIPTION OF THE DRAWINGS

FIG. 1 is a block diagram of an example environment for capturing and sharing content consistent with the present disclosure;

FIG. 2 is a block diagram of an example environment for capturing and sharing content consistent with the present disclosure;

FIG. 3 is a flowchart of an example method for capturing and sharing content consistent with the present disclosure;

FIG. 4 is a flowchart of an example method for referencing and sharing content consistent with the present disclosure; and

FIG. 5 is a block diagram of an example computing system consistent with the present disclosure.

### DETAILED DESCRIPTION OF EXAMPLE EMBODIMENT(S)

### Definitions

The term “digital video clip” is used broadly herein to refer to content captured by an image capturing device such as a digital camera and may be still pictures or images, and motion video images, or a combination thereof. The digital video clip may also include audio. Digital video clip may also be referred to as content or content data.

The term “image capturing device” is used herein to refer to a device that is capable of capturing an image or a video. For example the image capturing device may refer to a camera that is capable of capturing digital video. The image capturing device may include technologies such as semiconductor charge-coupled devices (CCD), active pixel sensors in complementary metal-oxide-semiconductor (CMOS), or N-type metal-oxide-semiconductor (NMOS, Live MOS) technologies. The image capturing device may also capture audio.

The term “content” is used herein to refer to images or video captured by an image capturing device such as a camera. The content may be digital and may include audio.

The term “tag” is used herein to refer to data or information that can be associated with the video and/or pictures or data that can be associated with data captured from a beacon. The tag can include, by way of example, text searchable data. In addition, the tags or data or information can include information from other sources, such as sensors, to include information such as the identity of a beacon, temperature, weather, altitude, speed, acceleration, etc. Such information can be compiled or bound to the content of the video. For ease of description, the terms spatial and/or temporal tags are used herein. The tags or data can be text searchable, and used to identify, compile, relate and/or synchronize the videos as well as artifacts in the content.

The term “scene” is used herein to refer to a physical environment where content, such as video, may be captured.

The term “beacon” is used herein to refer to a physical device associated with an artifact used to convey information that is used to identify the artifact to devices. The beacon may broadcast a wireless or radio signal with unique information used to identify the artifact. The beacon is not limited to any one means for conveying information, but rather refers generally to any means for conveying information. The artifact may be placed in a scene to be captured by a sensor associated with a device. The beacon may be embedded in an artifact, wearable by an artifact or otherwise attached to an artifact.

The term “artifact” is used herein to refer to a person, a physical object, a landmark, a structure, or a location. For example, an artifact may be captured in an image.

The term “identifying data” is used herein to refer to data captured from a beacon. The beacon may broadcast or display the data. The identifying data may identify an artifact associated with the beacon. As used herein, the term unique identifier may refer to identifying data.

### DESCRIPTION

As capturing content, such as images and videos, becomes more popular, so does sharing the content using techniques including social media. Moreover, as there is more content available on the Internet and social media, a user may desire to search for particular content including content related to the user and/or the user's identity. A user capturing and generating content may also wish to monetize their content and have it made easily searchable or discoverable by an interested party. The invention includes techniques for capturing and sharing content in a way that makes the content easily searchable to users especially to users associated with the artifacts captured in the content. For example, in one aspect, a device captures content in a scene with an image capturing device while simultaneously capturing identifying data from a beacon via a sensor. The device then binds together the content and the identifying data. This data that is now bound together can be used to identify an artifact in an image of the content including the identity of a person in the image. The bound together data can also be used to create tags that are text searchable identifying the artifacts in the image. Thus a search for the artifacts and other content captured in the image may be executed that will return results with this particular content. In one aspect, the invention automatically creates a tag identifying a person in a particular image by name such that a text search for the name of the person will return results with this particular image of the person. The binding may occur on location where the content was generated and may also associate location information with the content as metadata. The location information is then able isolate a user's proximity to other content that is created in a scene. Thus the content from two different users employing the invention may be associated and shared via the users' location data. The location data may be converted to a tag. A device may be able to captured identifying data from a plurality of beacons in a scene where each beacon may identify a different artifact in the scene.

In prior solutions a user would be required to manually create tags or otherwise associate the identity of an artifact or person in an image. Alternatively, techniques such as facial recognition were employed to identify a person or artifact in an image. However, facial recognition and other similar techniques are computationally intensive and slow and are therefore cannot be used on every image. The present invention overcomes these limitations by automatically creating tags related to the identity of a person or other artifact in a way that is not computationally intensive and that is not required to employ facial recognition.

In one aspect, the invention may include apps or software that is installed onto a device that is used for capturing content in a scene. The app may be used to bind together the content data and the identifying data. The app may also be in contact with a content server in a central location and can upload the images or video including the content data bound with the identifying data to the content server. The app may also be employed by a user to subsequently access the content generated by the user. The app may also be employed by the user to search for content generated by other users. In one aspect, the app with the content server is employed to monetize the content generated by the user.

In one aspect, after the identifying data and the content data have been captured and bound together, they may be sent to a central server or other location. For example, the device may be able to send the data to the central server over WiFi, a wired connection, or the device may be a satellite enabled device and may upload the data via a satellite connection to be ultimately sent to the central server. Thus a device in the field may be able to immediately send the data to the central server. In one aspect, the central server receives the identifying data and the content data bound together and analyzes the data. The analysis may be to create tags related to the content to make the content searchable such as using a text search. The identifying data may be analyzed to create a tag that is based on the identity of the artifact associated with the beacon that generated the identifying data. The multiple tags created at the central server may be crossed referenced to one another based on the binding that occurred at the device when the content was captured. The content data may be analyzed to create a tag based on the actual content captured in the image or video. For example, the pixels in the content data may be analyzed to identify what is in an image. Techniques such as facial recognition, optical character recognition, pattern recognition, or landmark or building recognition may be used to identify the objects in the content data. The analysis may be able to generically identify an object type but identity the unique identity of a given object. For example, techniques may be able to recognize that an image contains a flag, but not identity what type of flag it is or what the flag represents. Video may be analyzed on a frame by frame basis. The tags created based on the content data or the identifying data may be text searchable and may be associated with the content as metadata. The central server or content server may also use the created tags to associate a user's generated content with other content that was generated by other users. This association may be used by central server and the user to monetize the content generated by the user. The association may also be used to offer to sale other content to the user.

One advantage of the present invention is that the tags may be used in narrow searches for content. The tags based on identifying data make the artifacts in the generated content easily searchable. For example, a user may search for an image of herself with a flag desiring to find an image of herself with a particular flag. In prior solutions, a text search including the name of the user and the word “flag” may return thousands of images where none of the images are the one that the user desired. With the invention, a text search including the name of the user and the word “flag” will return the image the user desires because the name of the user may be a tag automatically created and associated with the image when the content was generated using the present technology. Thus narrow search results may return the content that the user desires. The invention may also be used to further narrow searches by the user based on location. For example, the user may search for content associated with the user's identity and a particular location where the user was in attendance.

In one aspect, a tag generated based on either the content data or the identifying data may be employed to spawn a routine or service. The service may be spawned locally via device 108 or maybe spawned via the content server 116. For example, the invention may employed by a user to order a pizza from a business. In such an example, a user may capture an image where a beacon or beacons in the image identifies the user, the business, the user's order, and/or a form of payment to be employed by the user. Other services or software routines may be initiated through use of the invention. In one aspect, the binding together the identifying data and content data spawns a locals service. For example, the device 108 may be locked regarding most features but is able to capture an image of the user and the identifying data from the beacon associated with a user. Once the content data and identifying data are bound together at the device, they may spawn a service of unlocking the remaining features of the phone. Thus the invention is used in place of or in conjunction with a password to unlock a device. In one aspect, the invention is employed to authenticate a user and unlock a car door. The invention may also be employed to spawn services that automatically adjust setting in an automobile or other device. For example, two people may share an automobile and each person has preferences regarding the position of the driver's seat, mirrors, and other settings. Upon approaching the automobile the invention may be employed such that the automobile recognizes or identifies the specific person and automatically adjusts the settings. This may be accomplished by components of the automobile itself capturing content data and identifying data regarding the person, or it may be accomplished using a mobile device associated with the person where the mobile device captures the identifying data and the content data and then sends a command to the automobile. In one aspect, a beacon associated with the automobile and a specific person may be embedded in a key or remote for the automobile. In one aspect, the invention may be employed for security purposes or protocols. For example, a user may employ the device to capture identifying data from a beacon. The beacon may be associated with an artifact that has a security feature such as a locked door. The identifying data is then sent to the central server where it is analyzed. The central server is able to determine that the user is within proximity to the locked door based on the fact that the user captured the identifying data associated with the beacon for the locked door. Based on the identity of the user and the identifying data, the central server may be able to determine that the user is authorized to unlock the door. The central server may be able to identify the user based on metadata generated by the device and sent to the central server with the identifying data. A signal may then be sent by the central server to the locked door where automated features will then unlock the door and allow the user to pass through. In one aspect, the invention may be used for multi-factor security purposes. Capturing a beacon and its identifying data may be a form of entering a password in a security protocol.

In one aspect, the invention may be used to authenticate a user to log into a secure system and then logout. For example, user 120 may use an automatic teller machine (ATM) for a banking transaction where the user is required to authenticate themselves. In prior solutions the user 120 may be required to insert a banking card into the ATM and enter a personal identification number or code. The user 120 is then authenticated and can perform a transaction via the ATM. In one aspect, an ATM may employ the invention to capture an image or content of a user and captured identifying data from the user from a beacon associated with the user. The ATM may then bind together content data and identifying data to authenticate that the user has authority to perform a transaction. The image data or content data may be analyzed using facial recognition to identify the user. The ATM may perform analyzing and tag creating locally or may employ content server 116 for such services. A user may then manually log out of the ATM system or may employ the invention to log out. For example, the ATM may have a modified antenna as a sensor that defines a range specifically around or in front of the ATM. For example, a user and their associated beacon may be required to stand directly in front of the ATM for the antenna to sense the identifying data from the user's beacon. After the user is authenticated, if the beacon leaves the predefined area then the sensor or antenna no longer senses the beacon and the user is logged out or is no longer authorized to perform transactions at the ATM. The sensor of the ATM may require the beacon to constantly broadcast identifying data or may sample the identifying data from the beacon at predefined time intervals such as every second or any other predetermined duration.

In one aspect, a security protocol may be used in conjunction with the invention to authorize a user over the phone. In a banking transaction, several factors may be employed to authorize or authenticate a user. For example, factors may include the phone number that a user is calling from, the voice print of a user, a recorded sample of the user's voice, a password or code said aloud or entered into the phone, etc. The invention may introduce additional factors based on the beacon and the identifying data. The identifying data may be captured by sensors associated with the user or by sensors associated with the other party such as the bank. In one aspect, the identifying data broadcast from the user's beacon is employed to authenticate the user. In one aspect, the party performing the authentication, such as the bank, will send an audible tone to the user to be recorded and interpreted by the user's device for authentication purposes.

In one aspect, a security protocol may be used in conjunction with the invention to authorize a user at a computer. A computer, including a desktop computer, a laptop, or a tablet, may have a camera positioned to capture an image or video of the user at the computer. The camera and/or other sensors at the computer may be employed to capture content of the user's likeness as well as identifying data such as data from a beacon associated with the user. For example, the user may have a smartphone that acts as a beacon and broadcasts identifying data to the computer system. The computer system may then use the identifying data and/or the image of the user to authenticate the user. This authenticator may be multi factor and used in conjunction with other protocols such as requiring the user to enter a password. It should be appreciated that embodiments of the present invention may be employed by users all over the world to capture content and tag the content based on identifying data associated with artifacts in the captured content. This content may then be shared and/or monetized by the users via the Internet or other network.

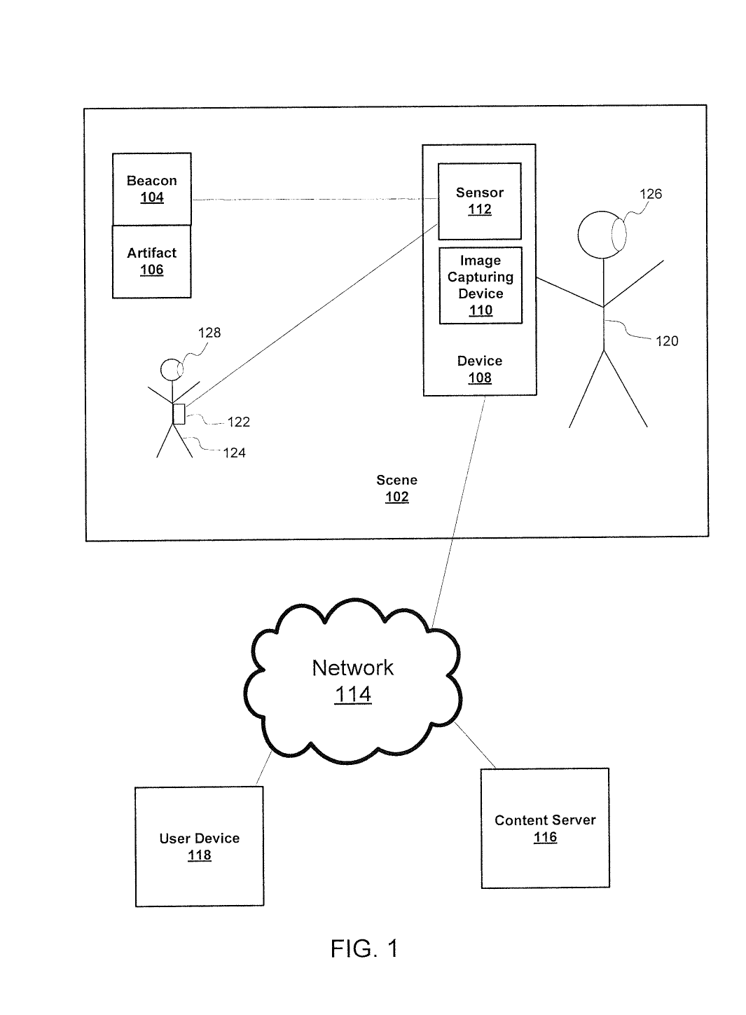

FIG. 1 depicts an environment for capturing and sharing content. The environment includes the scene 102 which is a physical location or environment in which the image capturing device 110 may capture an image. For example, the scene 102 may be an outdoor setting where recreational activities occur and participants or spectators, such as the user 120, capture images and video of the scene as well as the artifacts in the scene. One of the artifacts may be artifact 106 which may be a person, a physical object, a landmark, a structure, or a location. The artifact 106 may be associated with the beacon 104 which is a beacon that broadcasts or otherwise conveys identifying data regarding the identity of the artifact 106. For example, the artifact 106 may be an object like a skateboard where the manufacture of a skateboard embeds a beacon in all of their skateboards. Thus whenever the invention is used to capture an image where the skateboard is present in the scene 102, the sensor 112 will capture the identifying data broadcast by the beacon 104 in the skateboard. This may be desirable to a manufacture or company to assist in marketing, brand recognition, and associating their product with the users.

In one aspect, the beacon 104 may be device that is capable of broadcasting a radio signal and may employ a known protocol. For example, the beacon 104 may make use of technologies such as Bluetooth, WiFi, radio frequency identification (RFID), etc. The beacon 104 is not limited to radio signals but may also be any physical implementation for conveying information. For example, the beacon 104 may convey infrared using electromagnetic radiation, visible light, infrared, ultra violet, radio signals, sound, audible tones, sub audible tones, ultrasonic tones, optical patterns, or any other means that may be captured by a sensor. In one aspect, the beacon 104 is a visual pattern that points to other identifying data such as a barcode or a quick response (QR) code. An item such as a bar code may be associated with a person by printing the barcode on an article of clothing worn by the person. The invention may be able to the sense identifying data from a plurality of different types of beacons. For example, the app associated with the invention that is installed on the device 108 may have a database of protocols or other information that allows the device 108 to recognizes and sense the data from beacons made by different manufactures that use different protocols and techniques. Such a database may be routinely updated to include additional types of beacons. The device 108 may also have built in functionality that allows the app to sense beacons and identifying data. The identifying data broadcast by the beacon 104 may be static or dynamic. Dynamic identifying data may be employed for security purposes.

In one aspect, the device 108 employs the image capturing device 110 which may be a camera to capture content in the scene 102 while simultaneously capturing identifying data from the beacon 104. It should be appreciated that the sensor 112 and the image capturing device 110 may be built into the device 108 or may a separate component in communication with the device 108. For example, the wearable camera 126 may be an image capturing device associated with the user 120 and the device 108. The wearable camera 126 may be worn on the head or other portion of the user 120 and may wireless transmit data to the device 108. The device 108 may be a mobile electronic device and may be a smart phone, a tablet, a personal digital assistant, a laptop, etc. The device 108 may be held in the hand of the user 120 or stored in a pocket or otherwise worn. The device 108 or components of the device may be in contact with the user or may only be in close physical proximity to the user. In one aspect, the device 108 may be operated automatically without a user present. The person 124 is also depicted in the scene 102 with wearable camera 128, and device 122 which may be employed to capture content using the techniques of the invention. The device 108 is employed to capture content in the visible spectrum via the image capturing device 110 and may also capture other electromagnetic signals via the sensor 112. Thus the device 108 may be employed to capture what may be referred to as full spectrum content.

The content captured by the device 108 may be sent to the content server 116 over the network 114. Network 114 may be the Internet. The device 108 may be connected to the network 114 using wired connection, wireless connections, WiFi, Bluetooth, a satellite connection, other connection type. The content server 116 is capable of receiving content from devices such as device 108 and device 122 where the content comprises content data bound to identifying data. The content server 116 then analyzes the content data and identifying data to create tags based on the identity of the artifact as well as tags based on analyzing the images in the content data. The content server 116 may then cross reference these tags with one another as well as with other similar tags associated with other content. In order for the content server 116 to identify the artifact 106 based on the identifying data, the content server 116 may be required to have prior knowledge of the identifying data or be able to look up the identifying data. For example, the identifying data may simply be a number or code. The beacon 104 and the identifying data may not expresses know the identity of the artifact 106. The content server 116 may have access to a data base that correlates the number or code to the identity of the artifact 106. When the device 108 uses sensor 112 to capture the identifying data, the device 108 may not have not have access or the ability to look up this identity based on the identifying data. Thus the device 108 may only bind the identifying data to the content data to ensure that the identity of the artifact 106 will be subsequently tagged for the content.

In one aspect, the image capturing device 110 is associated with a third party such as an owner of the scene 102. The image capturing device 110 may be operated by an employee of the third party or may be mounted on a structure such as a wall. The image capturing device 110 may automatically capture images or content of the scene. The content may be captured on a periodic basis or may be captured whenever the sensor 112 associated with the mounted image capturing device 110 senses identifying data from a beacon. For example, image capturing device 110 may be mounted on a wall and the person 124 walks into a field of view of the image capturing device 110 and the sensor 112 senses identifying data broadcast from a beacon associated with device 122 carried by the person 124. This sensing then triggers the image capturing device 110 capture content of the person 124, bind the captured content with the identifying data which identifies the person 124 and send this data to the content server 116. The content server 116 then creates tags based on the identity of the person 124. The person 124 may then be able to subsequently search for the content. Alternatively, the third party may initiate contact with the person 124 and offer to sell the content to the person 124.

In one aspect, content may be captured by both the user 120 and the person 124 in the scene 102. The user 120 and the person 124 may be unknown to one another but are both present in the same physical environment. For example, the person 124 and the user 120 may both be in attendance at a ski resort and capturing content of the scene 102. The person 124 may capture content of user 120 including capturing identifying data broadcast by a beacon associated with device 108. The user 120 may capture content of the person 124 including capturing identifying data broadcast by a beacon associated with the device 122. Because the person 124 and the user 120 are unknown to one another, they may never exchange their respective content even though they may desire it. The invention allows the content to be discovered and shared between the person 124 and the user 120. The content server 116 may receive the content data bound with the identifying data respectively from the person 124 and the user 120, create tags based on the content data and the identifying data from each user and then associate the tags with one another.

The content generated by a user such as the user 120 with device 108 may be hosted on a page associated with user 120. For example, the content server 116 may host a social media network or may send the content to a social media network. The page may use the tags created by the content server 116 to automatically share and associated the content captured by the user 120 with other content available to the page. The other content may be content generated by other users employing the invention, or may be content generated elsewhere and available to the page. For example, the other content may be images or videos posted on public websites and discovered using generic search techniques. The other content may also be stock images supplied by a party interested in having their content associated with the content generated by the user 120. In one aspect, the other content is monetized and the page offers it for sale to the user 120 to be posted on the page associated with the user 120. For example, the content generated by the user 120 in scene 102 may be at a ski resort. The beacon 104 may be owned by the ski resort and thus the content generated by the user 120 will be automatically tagged with tags identifying the ski resort. The ski resort may employ this tag to identify the user 120 and or the user's page then offer stock images of the ski resort for sale or for free to the user 120.

In one aspect, a beacon is owned by a venue and only provides the identifying data to authorized users. In this example, the user 120 may not be authorized to receive the identifying data and still captures images or generates content within the venue using the app of the invention and uploads the content to content data. The data may be generated with timestamps and location information. Then subsequent to when the content was generated, the venue may release the identifying data to the user 120 and/or the content server 116. The content server 116 may then be able to employ the subsequent identifying data and bind it to the existing content data to create tags for the existing content data based on the identifying data. In other words the identifying data may be bound to the content data at later time and may be used at a later time to create tags. The timestamp and the location information associated with the existing content may be useful for associating which identifying data goes with which content data because the identifying data may also comprise timestamp data and location data.

In one aspect, a beacon or array of beacons owned by a venue may change their signal or identifying data based on the event occurring at the venue. For example, in the morning hours a venue may host a monster truck rally while in the evening the venue hosts a basketball game. The beacons owned by the venue may broadcast or convey different identifying data for the monster truck rally compared to the basketball game. Thus the content data bound with the identifying data from the venue will be different and will identify which event the content was captured at.

The user device 118 may be employed by the user 120 or a different party to access the content hosted by the content server 116. The user device 118 may be connected to the network 114 and may access the user's page hosting content generated using the invention. The user device 118 may be employed to execute searches returning results with the content generated by user 120. The user device 118 may be a computing device such as a desktop computer, a laptop, a smart phone, a tablet, etc.

In one aspect, content including content data and identifying data may be sent to a third party that may be referred to as a producer to produce new content based on the content captured by a user or a plurality of users. For example, two users who may be friends may attend the same event such as a party located at a venue. Both of these users may capture content using the invention to capture both content data and identifying data that is bound together at the users' respective devices and sent to the content server 116. The content server 116 then creates tags for the content. The content from both of these users is then sent to a produce to produce new content based on the users' experience at the party. The producer may employ the tags created by the content server 116 to search for other content. The other content may be stock content from the venue, content generated by the venue at the party, or content created from other parties at the event. The content from the other parties at the event may also employ the present invention such that the tags created for the content from the other parties are used to search for and find the other content.

It should be appreciated that the content server 116 may be a central server such as a standard server computer system. However, the content server 116 may also be a plurality of servers connected to one another via a network such as the network 114. In one aspect, the content server 116 is a plurality of computing device hosted in the network 114 and employ cloud computing techniques.

In one aspect, either the device 108 or the content server 116 may place a digital filter over the content generated by device 108. The filter may employ any number of well-known techniques. The filter may be added as a result of a command from a user or may be automatically added. The content server 116 may use the filter to create an additional tag for the content. This additional tag may be used to search for the content or associate the content with other content.

In one aspect, a user generating content may be behind the camera and thus will not appear in the content generated. However, the user is the creator of the content and it may be desirable to create tags based on the creator's identity. The invention may generate a data or metadata associated with the content generated by a user to identify the user as the creator. This data or metadata may be employed by content server 116 to create a tag identifying the user. In one aspect, beacon associated with a user may be employed to capture identifying data of the creator of the content. In one aspect, the device being employed to create the content may act as a beacon to itself and read its own identifying data to capture identifying data regarding the creator of the content.

In one aspect, the user generated content may use the device to capture content where the user is present in the content. This content may be referred to as a selfie. In one aspect, the app for the invention on the device may have a mode described as selfie mode used to capture content where the operator of the device is present in the generated content. When the app is used in selfie mode to capture content, the app may prompt the user to identify whether the user was present in the content after the content has been generated in selfie mode. The answer to the prompt may then be used to create a tag identifying whether or not the user of the device is present in the generated content.

In one aspect, the system and the method can include a central server or data storage device (e.g. the “cloud”), such as the content server 116, where multiple different digital image files from multiple different user's are submitted and stored. (The central server or data storage device can include one or more central servers or data storage devices that can be located in different locations that are physically close or remote with respect to one another.) The system and method can include a social media service to capture, compile, match and/or share video and/or pictures in space and time from multiple different perspectives or angles. The social media service can include the content server 116 and a web site through which the videos and/or pictures can be presented or shared, and through which the videos and/or pictures can be offered for sale.

In one aspect, the system can include one or more digital video cameras, such as the image capturing device 110, configured to capture video from one or more different perspectives or angles of scene 102. In another aspect, the system can include a digital video camera configured to capture point-of-view (POV) images. The system and method can include synchronizing multiple different videos and/or pictures from multiple different video cameras (or digital image sensors), from multiple different points of view or orientations or angles, and/or multiple different locations.

In one aspect, the digital video camera can be head borne and located at substantially eye level as is depicted by the wearable camera 126 and 128. The digital camera can be integrated into a wearable article (second wearable article), such as headphones, earbuds, eyeglasses, or clothing. The digital camera can include one or more remote image sensors carried by the wearable article, and remote from a host carried by another wearable article (first wearable article). The host can store the image signal from the image sensor, and store the image signal as a digital image file, and upload the digital image file to the central server or data storage device.

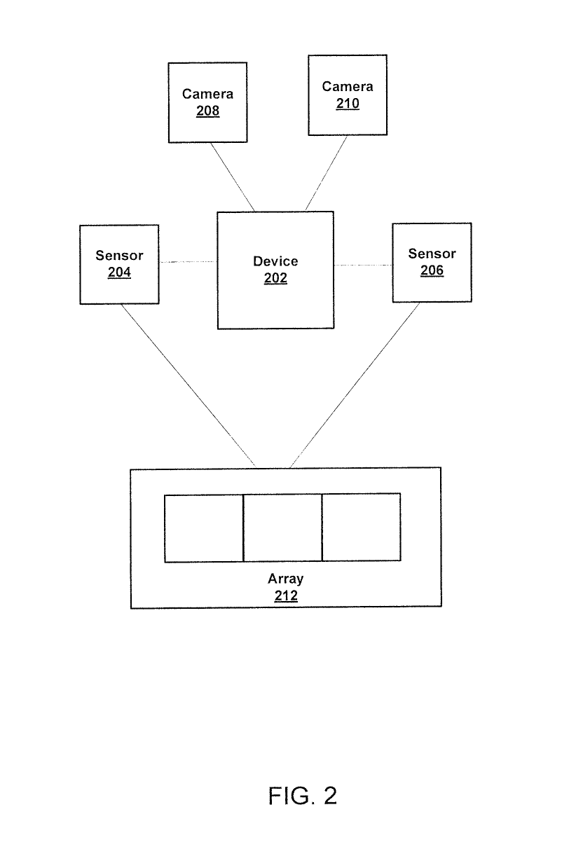

In another aspect, the system can include various different types of cameras and/or various different points of view as is depicted by the camera 208 and 210 in FIG. 2. In addition to user borne cameras or digital image sensors, the system can include other types of cameras, including for example, street or bird's eye cameras, vehicle mounted cameras, sports equipment such as ski tips, etc. As discussed below, the camera can include one or more digital image sensors, such as the sensor 112 of FIG. 1 and the sensors 204 and 206 of FIG. 2, that are remote from a host, and thus small enough to be located in tight locations, such as wheel wells, etc.

In another aspect, the camera and/or an associated sensor can capture or sense a unique identifier. The unique identifier may also be described herein as identifying data such as the identifying data that is broadcast by the beacon 104. For example, a user can have a unique identifier broadcast by the beacon that is wearable or carried by the user, and captured by the camera and/or sensed by the sensor, so that the unique identifier can be bound with the content data captured for the digital video file and then subsequently converted to a tag. The unique identifier or identifying data can include an RFID, a cellular phone, etc. In one aspect, the sensor can be associated with the camera, such as part of the camera or electrically coupled to the camera or host. In another aspect, the sensor can be remote or separate and discrete from the camera, and itself sensed by the camera to associate the unique identifier with the digital image file. Thus, the unique identifier can be cross-referenced with the digital image file.

The central server or data storage device can synchronize (group or associate) various different digital image files from various different user's (and various different cameras) base on temporal and spatial proximity (using time and geographical location tags of the digital image files), and present the co-temporal and co-spatial digital image files as a group. In another aspect, the system or method can synchronize the different digital video files base upon other tags (as described above). Thus, the various different digital image files can be combined for a more complete or supplemented video experience. In one aspect, user's can find themselves in digital video clips from other users to supplement their own digital video clip.

The content server 116 or data storage device can include a website and or computer program/software to receive and store multiple different digital video clips or digital image files from various different users, and various different cameras. The digital image files can include time tags and geographical location tags that identify when and where, respectively, the digital video clips were captured or recorded. The central server or digital storage device, or the computer program/software, can synchronize, or group or associate, the various different digital image files based upon a predetermined temporal proximity and a predetermined geographic/spatial proximity. The central server or data storage device can accumulate or receive submissions of a plurality of digital video clips or digital images files, along with the associated time tags and geographical location tags. The computer program/software can compare the time tags and geographical location tags of the digital video clips or digital image files based upon the predetermined temporal and spatial proximity. The computer program or software can group or associate co-temporal and co-spatial digital video clips or digital image files (or based on other tags). The grouped or associated co-temporal and co-spatial digital video clips or digital image files can be presented together, such as on the website. In addition the computer program/software can inform a first user (who submitted a first digital video clip or digital image file) of a second digital video clip or a digital image file of a second user based upon the temporal and geographical/spatial proximity of the first and second digital video clips or digital image files. In one aspect, the predetermined temporal and geographical/spatial proximity can include over lapping temporal time periods and visual proximity, respectively. The central server or website or social media service can display or present other video clips that are related to the current video clip being uploaded and/or viewed based upon the tags (i.e. spatial and temporal proximity), number of views, similar video clips, similar users, etc.

In one aspect, a first user may record a digital video clip of an event (such as concert or a sporting event in which the first user is participating or viewing). The first user's camera can record a digital image file of the first digital video clip, along with a time tag indicative of the time of the video clip, and a geographical/spatial location tag indicative of the geographical/spatial location of the video clip. The digital video file can be uploaded to the central server or digital storage device. In one aspect, the digital video file can be uploaded manually by the first user. In another aspect, the digital video file can be uploaded automatically by the camera (or host, as described below). In another aspect, the digital video file can be uploaded and tags can be manually added. Similarly, a second user can capture or record a second video clip that may be in visual proximity to the first, and have an overlapping or proximal temporal time period. The computer program/software can synchronize, or group or associate, the first and second digital video files based on the predetermined temporal and geographic/spatial proximity. The two digital video files can be presented on the website. In one aspect, the computer program/software can allow searching of the files based on time period and/or geographical location, or other searchable tags. In another aspect, the computer program/software can inform the first user of the second digital video clip or digital image file. Similarly, the computer program/software can inform the second user of the first digital video clip or digital image file. The first and second digital video clips or digital image files can be presented together for viewing.

In another aspect, tags can be manually associated or saved with the digital image file. For example, older or preexisting video clips can be uploaded and saved to the central server, and tags added indicative of temporal and spatial creation, or other data. Thus, the method and system can bridge old and newer video clips.

In another aspect, the users can sign up for a service provided by the central server or digital storage device, and/or the computer program/software, and/or the website. In one aspect users can agree to provide their digital video clips for use by the owner of the central server or digital storage device or operator of the computer program/software or website, and/or for sale to others for value, such as a monetary value. The digital video clips can be offered for sale, and can be purchased by other users, again for monetary value. The owner of the central server or digital storage device, or provider of the computer program/software or website, can earn a commission or percentage of the sale.

In another aspect, the system and method, or the central server, web site, and/or social media service, can include different levels of privacy settings to allow or disallow viewing and/or searching to select predetermined individuals or groups. A user can designate whether the video clip is to be public, private, or limited viewing. The user can also designate whether or not the video clip is to be encrypted. The video clips can include a key, a password protection, and/or a public/private key of PPK encryption. Thus, the video clips can be stored by the central server, but the tags may not be searchable and/or the video may not be viewable.

In another aspect, the owner or provider of the central server or digital storage device can charge for storage of the digital video clips. In another aspect the owner of the central server or digital storage device can offer storage of the digital video files for free. In another aspect, the owner of the central server or digital storage device, or provider of the computer program/software or website, can combine edit or otherwise produce a compilation video based on the various different videos clips, and offer such group video for sale.

The video capture and sharing system of the present invention allows a story to be told through videos and pictures based on a point of view camera angle in which various different perspectives are captured and combined to tell the story. These various different angles or perspective are combined or linked based on their temporal and spatial proximity. The various different perspectives can be crossed reference and synchronized together based on their temporal and spatial proximity. The computer program and website can provide a social media aspect where groups of camera shots can be presented of various different events. Providing different video clips for sale can provide an incentive for many different users to capture one another, and others on video.

In another aspect, other different cameras or perspectives can be provided as well. For example the other cameras could involve stationary aerial shots of geographic locations, such as ski slopes concert venues, landmarks, etc.

In another aspect, owners of cameras could provide digital video clips of popular areas or setting or landmarks, and upload such video (along with time and geographic tags) to the central server or digital storage device for purchase. Again, the owner of the central server or digital storage device, or provider of the computer program/software or website, can earn a commission or percentage on such sales.

In another aspect, video clips can be auction for sale to the highest bidder. Such auction digital video clips could include video of noteworthy events, such as news, crime, weather, etc. In another aspect, a venue or performer could provide cameras of the entire venue or performance, to be combined with other user's video for sale.

In another aspect, the tags and/or user profiles can be utilized for data mining to provide advertising for products or services, or to gather information or data on products and services. The central server, website or social media service can charge for data collected from the users and video clips. In addition, data or information, such as advertisements, website links, etc., can be provided to the user, such as in real time on a cellular phone (via text message, in-app messaging, email, etc.), or in the digital video file. For example, advertisements can be provided (in real time or in video clips) based on the spatial location of the user or geographical location of the recorded video. As another example, advertisements can be provided (in real time or in video clips) based on products sensed by sensors where the video is captured.

As described above, the system can include a plurality of different cameras from different perspectives. For example, the cameras can include one or more digital image sensors located at eye level. In one aspect, the one or more digital image sensors can be head borne. The digital image sensors can be carried by and/or incorporated into a wearable article, such as head borne wearable article (i.e. second wearable article). For example, the second wearable article can include an audio head phone, an ear bud, a pair of eye glass, a pair of sunglasses, etc. The digital image sensor can be incorporated into a housing of the wearable article. For example, the digital image sensor can be incorporated into the housing of the headphone, the ear bud, or the glasses. Thus, the image sensor can be carried by the wearable article at substantially eye level.

In addition, the digital image sensors can be remote image sensors remote from a host. The host can have a battery powered source to provide power to the image sensor, a wireless transceiver to upload digital images files to the central server, a digital memory device to store the digital image file, and one or more processors. For example the host can be a cellular phone, a digital music player, etc. The host can be carried by another wearable article (i.e. first wearable article). The first wearable article can include a pocket, such a user's pants, jacket, shirt, purse, etc. The remote image sensors being remote form the host allows the digital image sensors to be remotely located in a convenient way.

The remote image sensors can be coupled to the host either by wires, or wirelessly. In one aspect, the digital image sensors can be coupled to the host by a wire, and carried by a wire associated with the second wearable article. For example, the digital image sensor can be carried in housing of head phones or ear buds, and include a wire from the digital image sensor alongside the audio wire to the host. A cable can be coupled between the second wearable article and the host, and can include an audio wire extending from an audio jack of the host to a speaker or a sound transducer of the second wearable article (headphones or ear buds), and a data wire extending from the a data port of the host to the remote image sensor.

In another aspect the second wearable article can further comprise a battery power source and a transceiver to remotely couple the digital image sensor to the host. For example the remote digital sensor can wirelessly couple to the host via Bluetooth or other wireless transmission protocol.

In one aspect, the at least one remote image sensor can and/or the host can have a rechargeable battery. In another aspect, the at least one remote image sensor can and/or the host can be powered by an alternative power source, such as a solar panel, electrical generation equipment, that can be built into the camera with rechargeable batteries, or as separate devices not in the same housing but connected by wires.

The at least one remote image sensor can be capable of converting light incident thereon to an image signal, and transferring the image signal to the memory device of the host. The host can be capable of storing the image signal as a digital image file in the digital memory device. The at least one processor of the host can be configured to establish a time tag and a geographical location tag with the digital image file of the digital video clip.

In addition, the at least one processor can establish a wireless connection between the wireless transceiver of the host and a wireless network. Thus, the host can transfer a copy of the digital image file, and the associated time tag and geographical location tag, from the digital memory device of the host to the central server or data storage device.

In one aspect, the image sensor itself, and/or another sensor housed with the image sensor or the host, or otherwise associated with the image sensor or camera can be capable of sensing a sensor, transmitter or pin or dongle in the view of the camera or image sensor, or the vicinity of the camera or image sensor. The sensor can sense or identify a unique identifier associated with the sensor, transmitter or pin or dongle, and create a tag of the unique identifier with the digital image file. In one aspect, the sensor may sense a pin or dongle or cellular phone of a user and save the unique identifier of the user with the digital image sensor. The user (or the service) can then search the digital image files for the unique identifier to identify the user in the video clip or proximity of the video clip. In another aspect, the user or the service can cross-reference geographical location and time data of the cellular phone with spatial and temporal tags of the videos to determine which video clips the cellular phone, and thus the user, are recorded in.

In another aspect, the digital image sensor and/or the host and/or the camera can record continuously in a loop. The user can selectively save a segment of the video clip captured from the digital image sensor after the scene or event has occurred, and while the video clip is still queued. For example, after viewing a scene or event, a user can press a button on the digital image sensor and/or host (or cable associated therewith) to cause the host to save a predetermined length of the video clip that is in the que. As another example, the user can audibly toggle the host to save the predetermined length of the video clip. As another example, the host can have voice recognition and an audio sensor to cause the host to save the video clip. The voice recognition can also recognized a length of time articulated by the user to save the articulated length of time.

In one aspect, the system and method can include downloadable software, such as a mobile application that allows the user to capture video clips, save the video clips with temporal and spatial tags, and upload the video clips to the central server. In addition, the downloadable software and/or mobile application can allow the user to receive notifications of other video clips that were captured in the same temporal and spatial proximity. The downloadable software and/or mobile application can allow the user to preview the other video clips, and/or purchase the other video clips. In another aspect, the user can be notified of other video clips by text message, in-app messaging, e-mail, etc. In another aspect, the downloadable software and/or mobile application can provide for organizing and editing video clips. For example, the downloadable software and/or mobile application can allow a user to splice or otherwise combine his or her own video clips with the other video clips. The downloadable software and/or mobile application can allow the user to access, post, display, tag, blog, stream, link, share, or otherwise manage the video clips.

Similarly, the website can also provide the user with groups of video clips that were captured in the same temporal and spatial proximity to those uploaded by the user. In addition, the website can allow the user to search for related video clips based on temporal and spatial proximity, and/or type of activity. The website can allow the user to preview the other video clips, and/or purchase the other video clips. In another aspect, the website can provide online blog journals, etc. In another aspect, the website can provide for organizing and editing video clips. For example, the website can allow a user to splice or otherwise combine his or her own video clips with the other video clips. The website can allow the user to access, post, display, tag, blog, stream, link, share, or otherwise manage the video clips. The website can display the video clips. The clips can be visually represented based on factors. For example, clips can be presented geographically or temporally. The visual graphics can be enlarged or enhanced based upon greater number of clips, greater number of views, etc. Thus, the website or social media service can utilize informational graphs where information is weighted based on use, and presented graphically weighted on the user so that greater use is visually enhanced (size or brightness). For example, the size of the graphic of the video file is larger for greater presence of a tag (e.g. individual, location, etc.). In one aspect, the tags can be listed, and visually represented with the greater number of tags visually enhanced.

In another aspect, the website or service can allow for a user to create a page that is public, private, or both. The page can present the user's video clips and/or photos along with any other personal profile information. In addition, related (temporal, spatial, or other) video clips can also be presented. The user can choose to share videos on the page. Other users can select and add the videos to their videos or page. The service or website can allow for advertising or sponsorship.

In one aspect in accordance with the present invention, the website or service can provide (or sell) features that can be added to, overlaid with, integrated with, interpose, the user's video clip or photo. The features can include pictures or videos of celebrities, likenesses of celebrities, stock photos or videos, 3D models, famous geographic features or locations, famous or well-known objects, backgrounds, events, news, CGI effects (explosions, fictitious characters, etc.), etc. The features can be provided with different use rights, and priced accordingly. The rights can be limited to personal use, or can include public use, or even sale to others (such as allowing the user to sell a combined video clip or photo). The license can be bound with the feature or stock video clip or photo, such as described with respect to the digital tags above. The features or stock photos or videos can include instructions or other information to assist in integration with the user's video clip of photo. Such instructions can include positions and/or orientations to pose in order to facilitate integration. The website or service, and/or downloadable software or app, can interpose or blend the user's video clip or photo with the feature or stock video clip or photo to make a final combined video clip or photo.

In one aspect, the website or service, and/or downloadable software or app, can identify, or can be configured to identify, various visual acuities, similar to that described above with respect to unique identifier of subject (e.g. RFID tag, cellular phone, etc.). Such visual acuities can include a color, a shape, a brand, a bar code, etc. The website or service, and/or downloadable software or app, can convert the visual acuities into digital tags bound to the user's video clip or photo. The visual acuity tags can be added to the user's video clip or photo as the clip or photo is uploaded to the website or service, added as a tag, or the website or service can search the user's video clip or photo for visual acuities that can be added as tags.

In one aspect, the website or service, can manage the tags. The website or service can sell the tags to clients, along with other data. The website or service can allow for searching or tabs or visual acuities. The

In one aspect, the website or service can monetize the user's video clip or photo in several ways. The website or service can facilitate the sale of the video clip from one user to another (peer to peer sale) and make a commission or percentage of the sale. The website or service can sell features or stock video clips or photos to user's to add to their video clips or photos to form a combined video clip or photo. The website or service can sell the digital tags or visual acuities to advertisers or the like. Advertisers or brand owners can search the tags or visual acuities to find relevant clips or photos in which they have an interest. The website or service can facilitate the sale of the video clip or combined video clip from a user to an advertiser. Again, the website or service can make a commission or percentage of the sale. The owner of the feature or stock video clip or photo can also earn a commission or percentage of the sale. The website or service can provide a marketplace or clearinghouse for digital content.

Multiple entities, such as three entities can be involved with monetizing digital content, including: 1) the user as a content creator (who can sell his or her content as video clips or photos, or combined video clips or photos); 2) the website or service as a marketplace or clearinghouse of digital content (who can make a percentage of sales, and sell features, and sell data); and 3) a producer. The producer can curate and promote digital content. The producer can edit, condense, and/or combine video clips or photos. The producer can increase the likelihood of sale of the digital content, and can increase the value of the digital content.

In one aspect, the invention can include a system and/or method to monetize digital content. In one aspect, such a system and/or method can incentivize the creation and refinement of digital content. The system and/or method, through the website or service, can register producers. The website or service can require a producer to provide a buy-in and/or a predetermined number of new users (as digital content creators and/or producers). Thus, the system and/or method can require a producer to buy-in. The producer can make a percentage or commission on the sale of digital content. The system and/or method can limit the commission or percentage, or the total amount earnable by the producer, based on the amount of the buy-in. The producer can broker digital content.

In one aspect, the website or service, and/or downloadable software or app, and/or the digital image sensors or cameras, can be utilized as, or part of a security system and/or home automation. Such a security system can eliminate door/window sensors. The digital image sensors or cameras can be positioned or angled to look straight down, or can be positioned in closets or other dark areas and can turn on when light is sensed, either by the digital image sensor or another light sensitive element. The digital image sensors or cameras can be positioned to view certain attributes to use as one or more virtual switches. For example, the digital image sensors or cameras can be positioned to view weather, such as rain. The digital image sensors or cameras can be positioned to view the lawn or other outdoor areas. The website or service, and/or downloadable software or app, and/or the digital image sensors or cameras, can identify visual acuities, such as rain, and can add a visual acuity tag along with time and date, geographic location tags, and duration tags. The tags, such as the visual acuity tag associated with the weather or the like can act as virtual switches. The website or service, and/or downloadable software or app, and/or the digital image sensors or cameras, can identify, or can be configured to identify, various visual acuities and/or digital tags, and treat them as virtual switches to take a predetermined action, such as turning on sprinklers, modify watering program, closing window, garage doors, etc.

In another aspect, the website or service, and/or downloadable software or app, and/or the digital image sensors or cameras, can be utilized as, or part of a traffic control system where the digital image sensors or cameras are positioned to view traffic or vehicles as visual acuities, and create visual acuity tags that can be sensed to change the programming of traffic lights. The digital image sensors or cameras can sense how backed up certain roads are, or how many cars are lined up in a given area, to create a more fluid traffic pattern programming.

In another aspect, the website or service, and/or downloadable software or app, and/or the digital image sensors or cameras, can not only determine the presence of a tag or visual acuity, but the duration of the tag or visual acuity, or how long the tag or visual acuity is present. Similarly, the website or service, and/or downloadable software or app, and/or the digital image sensors or cameras, can create a tag indicative of the duration of a tag or visual acuity. For example, the visual acuity and associated tag could be indicative of rain, and the duration of the rain.

In another aspect, the website or service, and/or downloadable software or app, and/or the digital image sensors or cameras, can be, or form part of, digital signage. The website or service, and/or downloadable software or app, and/or the digital image sensors or cameras, can sense a tag or visual acuity of a particular product or brand, and can present the user with an advertisement in real time. Thus, advertising can be targeted.

In one aspect, the second wearable article can comprise multiple different digital image sensors oriented to face in different directions. For example, one digital image sensor can be configured to face forward in the direction the user is looking, while another digital image sensor is configured to face laterally with respect to the user. Thus multiple different perspectives can be captured.

The one or more remote digital image sensors can form satellite cameras with respect to the host.

The host can comprise software and or computer programs to provide anti-shake, different filters and/or different textures for the image. The camera, software or service can provide video effects, such as stop motion, etc.

In another aspect, the predetermined temporal and/or spatial proximity can be variable, or can be varied to obtain more or less results.

In one aspect, the host and/or the digital image sensors can operate with video compression, and can provide a single video stream, rather than multiple video streams. In another aspect, the digital image sensors and/or host can operate on a timer to obtain sequential views from the multiple digital image sensors. The timer can be user operated to define a kind of user definable video compression. For example, the timer can operate the front image sensor for one minute, the side image sensor for one minute, and the rear image sensor for one minute. The host and/or the digital image sensors can include a indicator to indicate the change between the image sensors, such as an audible indicator, a visual indicator, etc.

In another aspect, the tags can include facial recognition information. The central server or social media service can scan the videos and implement facial recognition programs to identify individuals in the video files and add a tag with a unique identifier of the individual so that video files or clips of the individual can be compiled.

In another aspect, the system and method of the invention can be utilized for product testing by including a unique identifier on a product and follow the product through public cameras that capture the product, along with other information or data, such as temperature, speed, etc.

In another aspect, the system and method can include a kiosk that can take a picture and upload it to the central server along with a tag indicative of a unique identifier of the user so that the video or picture can be accessed later.

In another aspect, the system and method can include cameras at an event or venue, such as an amusement park, to capture video and/or pictures along with tags indicative of unique identifier of the user so that the videos or pictures can be accessed later. The owner or operator of the cameras can charge for the pictures or videos.

In another aspect, a user can utilize multiple different cameras or multiple different image sensors to capture video from multiple different perspectives so that the user himself or herself can provide a cinematography effect. For example, one image sensor can be user borne, another image sensor can be borne by a third party, another image sensor can be vehicle borne such as in the vehicle while another can be mounted in a wheel well.

In another aspect, the camera can include the capability to follow an object. In one aspect, the object can include a pin or dongle or transmitter that can be sensed by the camera or an associated sensor. The camera can follow electronically with the image sensor, or mechanically with a mechanism, such as a gimble or yoke with actuators, to orient the camera. The camera can create a tag based on the pin or dongle or transmitter that creates a unique identifier.

In another aspect, the user can create or obtain a unique identifier that is capable of being sensed or can transmit such that a tag is created by cameras and/or sensors that capture video of the user. The user can create an account or profile with the social media service, website and/or central server that compiles all video files that capture the user's unique identifier. Thus, users can designate setting to capture themselves from available public cameras. The public or available cameras and/or sensors can be configured to capture or upload or save video files whenever the unique identifier is sensed. The unique identifier can be associated with, or the pin or dongle or transmitter can be, a cellular phone, or other discrete pin. In one aspect, different databases can be cross-reference. For example, existing cell phone data can be cross-referenced with the tag database of the central server. The temporal and spatial information of the cellular phone, can be cross-references with the temporal and spatial tags of videos files to find video files that capture the cellular phone, and thus the user. So unique identifiers (e.g. cellular phones) can be cross-references with cameras or digital image sensors. In another aspect, another type of pin or transmitter can be sensed by sensors or cameras or digital image sensors and associated with temporal and spatial tags.

In another aspect, the video captured by the digital image sensor can also include audio associated with the video. A microphone can be housed with the digital image sensor, and/or can be housed with the host. The host can save the video along with the audio. In addition, the service or web site can include editing ability to allow the user to add audio over the video, such as a narrative, or exclamation, etc.

In another aspect, the service or website can include editing software or programs to allow the user or another user to combine video, modify the video, provide special effects, etc.

In another aspect, the service, host, or image sensor can include image stabilization software.

In another aspect, the digital image sensor or camera can be disposable.

FIG. 2 depicts device 202 which may have all the same features and capabilities of device 108 of FIG. 1. Device 202 depicts embodiments where some components of the device 202 are not built in to device 202. For example, camera 208 and camera 210 may be image capturing device such as image capturing device 110 of FIG. 1 but are remote to device 202. Similarly sensor 204 and sensor 206 are remote to device 202. Such cameras and sensors may be remote but still proximate to device 202. For example, device 202 may be a smart phone in a pocket of a user while the cameras and sensors are attached to the user in other locations such as on the head or shoulders of the user, or held in the hand of the user. FIG. 2 also depicts that the device 202 may have a plurality of cameras and sensors associated with it. In one aspect, the sensors are able to detect or capture identifying data from array 212. Array 212 may be a plurality of beacons. For example, the three boxes in array 212 may be three different beacons. The beacons may be the same as one another and broadcast the same identifying data, or the beacons may be unique relative to one another but still employed to identify the same artifact. For example, array 212 may be associated with an environment and mounted on a wall or other structure. The desire may be for the identifying data associated with array 212 to be captured by several different types of sensors. Thus the plurality of beacons may boost signal strength, exposure, or coverage area of the array 212. Additionally, the different beacons may broadcast on different frequencies or employ different techniques so that different sensors will each be able to capture the identifying data broadcast by the array 212. In one aspect, the array 212 may employ Bluetooth, RFID, and a barcode.

Various aspects of a wearable video camera are described and show in U.S. Pat. No. 8,730,388, issued May 20, 2014, and filed as U.S. patent application Ser. No. 13/204,242, on Aug. 5, 2011, and entitled “Wearable Video Camera with Dual Rotatable Imaging Devices”; which is hereby incorporated herein by reference.

### Operations

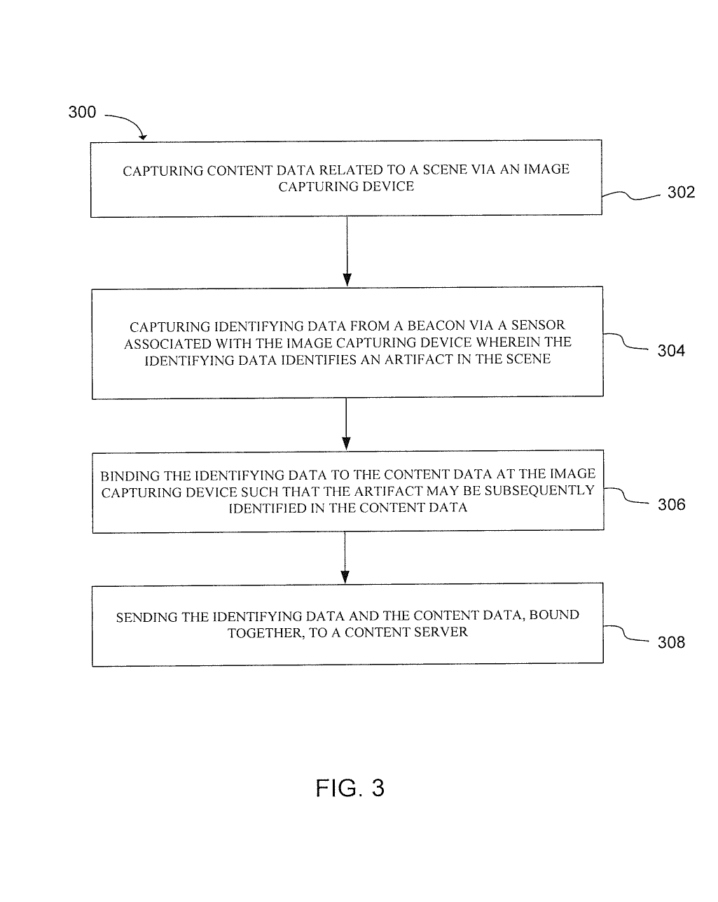

FIG. 3 is a flowchart of one example of a method 300 for capturing and sharing content. In one example, method 300 is carried out, at least in part, by processors and electrical user interface controls under the control of computer readable and computer executable instructions stored on a computer-usable storage medium. The computer readable and computer executable instructions reside, for example, in data storage features such as computer usable volatile and non-volatile memory and are non-transitory. However, the non-transitory computer readable and computer executable instructions may reside in any type of computer-usable storage medium. In one example, method 300 can be performed by devices in FIGS. 1, 2, and/or 5.

At 302, the process includes capturing content data related to a scene via an image capturing device. For example, the scene may be scene 102 and the image capturing device may be image capturing device 110 of FIG. 1. The content data may be digital data that is captured by a digital camera for an image or video. The content data may also include audio.

At 304, the process further includes capturing identifying data from a beacon via a sensor associated with the image capturing device wherein the identifying data identifies an artifact in the scene. The beacon may be beacon 104 of FIG. 1. The identifying data may be optical information such as a barcode or may be a radio signal and associated with a protocol such as Bluetooth, WiFi, or RFID. The sensor may be more than one sensor and may be built into the device or may be separate. The beacon may be a plurality of beacons each associated with a different artifact or may be an array of beacons associated with a single artifact. The artifact may be a person, a physical object, a structure, a landmark, or a location

At 306, the process further includes binding the identifying data to the content data at the image capturing device such that the artifact may be subsequently identified in the content data. The device may or may not be able to interpret the identifying data to actually identify the artifact. By binding the identifying data to the content data, the device ensures that the content will be associated with the content or image. Therefore, the content server may analyze the identifying data and create a tag based on the identity of the artifact in the image. Then the content data or the image will be automatically tagged with the identity of the artifact in the image.

At 308, the process further includes sending the identifying data and the content data, bound together, to a content server. In one aspect, the sending spawns a service or software routine. In other words, a user may use the invention to capture an image or video with identifying data from a beacon and it will spawn a service. The content server may have prior knowledge of what the identifying data identifies or may be able to look up that data.

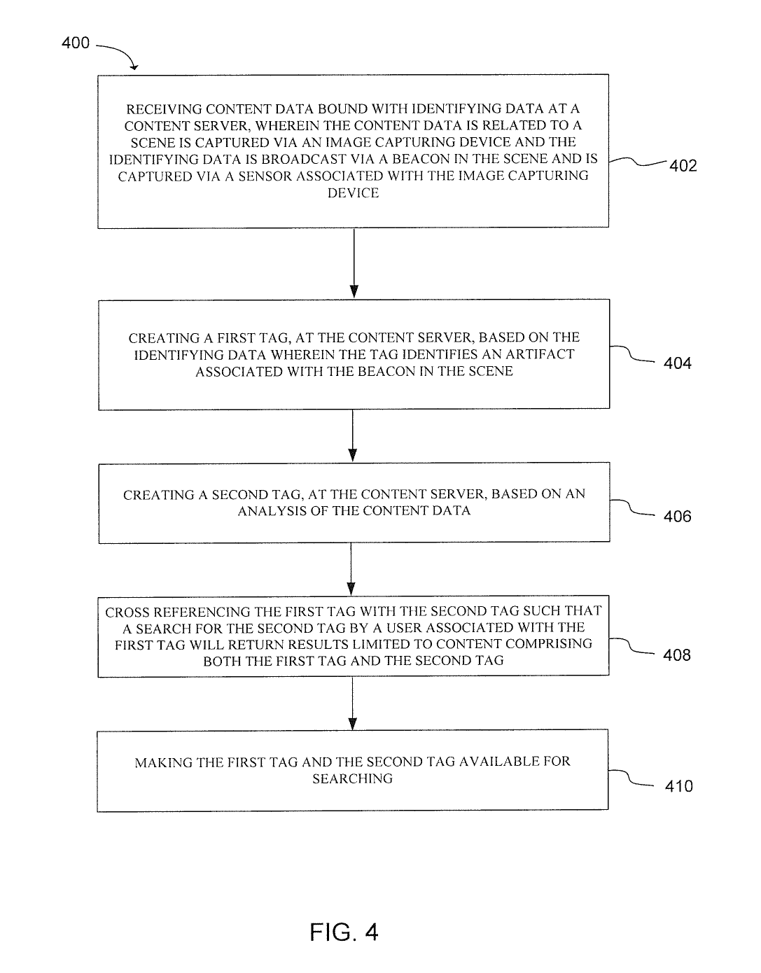

FIG. 4 is a flowchart of one example of a method 400 for capturing and sharing content. In one example, method 400 is carried out, at least in part, by processors and electrical user interface controls under the control of computer readable and computer executable instructions stored on a computer-usable storage medium. The computer readable and computer executable instructions reside, for example, in data storage features such as computer usable volatile and non-volatile memory and are non-transitory. However, the non-transitory computer readable and computer executable instructions may reside in any type of computer-usable storage medium. In one example, method 400 can be performed by devices in FIGS. 1, 2, and/or 5.

At 402, the process includes receiving content data bound with identifying data at a content server, wherein the content data is related to a scene is captured via an image capturing device and the identifying data is broadcast via a beacon in the scene and is captured via a sensor associated with the image capturing device. The content server may be content server 116 of FIG. 1.

At 404, the process further includes creating a first tag, at the content server, based on the identifying data wherein the tag identifies an artifact associated with the beacon in the scene. The first tag may be the name of the artifact such as the name of a person. The content server may have prior knowledge of the identifying data to be able to identify the artifact or may be able to look up this knowledge. The first tag may be a text searchable tag.

At 406, the process further includes creating a second tag, at the content server, based on an analysis of the content data. The analysis of the content data may analyze the pixels of the content and may analyze a video on a frame by frame basis. In one aspect, techniques such as facial recognition, optical character recognition, or other recognition techniques are employed to analyze the image.

At 408, the process further includes cross referencing the first tag with the second tag such that a search for the second tag by a user associated with the first tag will return results limited to content comprising both the first tag and the second tag.

At 410, the process further includes making the first tag and the second tag available for searching. The search may be requested by the user who created the content, a person who was captured by the content, or by a third party.

### Example Computer System Environment

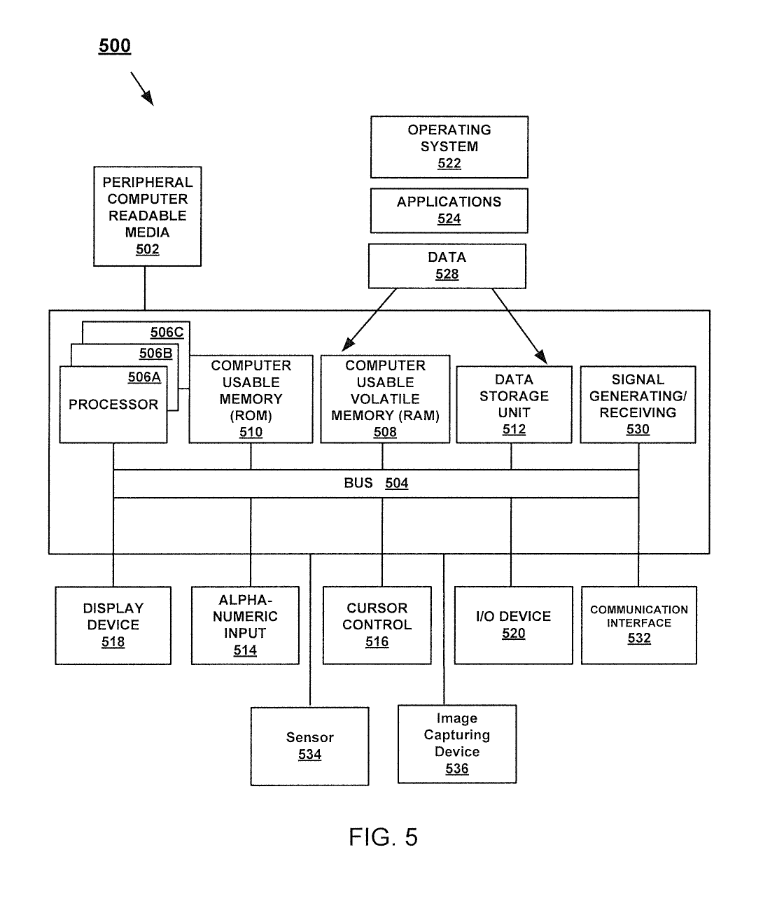

With reference now to FIG. 5, portions of the disclosure for providing a communication pathway composed of non-transitory computer-readable and computer-executable instructions that reside, for example, in computer-usable media of a computer system. That is, FIG. 5 illustrates one example of a type of computer that can be used to implement examples of the present disclosure. For example, either the server 102 or the user device 108 of FIG. 1 may be a computer system such system 500. The server 102 or the user device 108 of FIG. 1 may have some, all, or none of the components and features of system 500.

FIG. 5 illustrates an example computer system 500 used in accordance with examples of the present disclosure. It is appreciated that system 500 of FIG. 5 is an example only and that the present disclosure can operate on or within a number of different computer systems including general purpose networked computer systems, embedded computer systems, routers, switches, server devices, user devices, various intermediate devices/artifacts, standalone computer systems, mobile phones, personal data assistants, televisions and the like. As shown in FIG. 5, computer system 500 of FIG. 5 is well adapted to having peripheral computer readable media 502 such as, for example, a floppy disk, a compact disc, a hard drive, a solid state drive, magnetic media, or the like, coupled thereto.

System 500 of FIG. 5 includes an address/data bus 504 for communicating information, and a processor 506A coupled to bus 504 for processing information and instructions. As depicted in FIG. 5, system 500 is also well suited to a multi-processor environment in which a plurality of processors 506A, 506B, and 506C are present. Conversely, system 500 is also well suited to having a single processor such as, for example, processor 506A. Processors 506A, 506B, and 506C may be any of various types of microprocessors. System 500 also includes data storage features such as a computer usable volatile memory 508, e.g. random access memory (RAM), coupled to bus 504 for storing information and instructions for processors 506A, 506B, and 506C.

System 500 also includes computer usable non-volatile memory 510, e.g. read only memory (ROM), coupled to bus 504 for storing static information and instructions for processors 406A, 406B, and 406C. Also present in system 500 is a data storage unit 512 (e.g., a magnetic or optical disk and disk drive) coupled to bus 504 for storing information and instructions. System 500 also includes an optional alpha-numeric input device 514 including alphanumeric and function keys coupled to bus 504 for communicating information and command selections to processor 506A or processors 506A, 506B, and 506C. System 500 also includes an optional cursor control device 516 coupled to bus 504 for communicating user input information and command selections to processor 506A or processors 506A, 506B, and 506C. System 500 of the present example also includes an optional display device 518 coupled to bus 504 for displaying information.

Referring still to FIG. 5, a display device 518 of FIG. 5 may be present, such as a liquid crystal device, cathode ray tube, plasma display device or other display device suitable for creating graphic images and alpha-numeric characters recognizable to a user. A cursor control device 516 can also be present and may allow the computer user to dynamically signal the movement of a visible symbol (cursor) on a display screen of display device 518. Many implementations of cursor control device 516 are known in the art including a trackball, mouse, touch pad, joystick or special keys on alpha-numeric input device 514 capable of signaling movement of a given direction or manner of displacement. Alternatively, it will be appreciated that a cursor can be directed and/or activated via input from alpha-numeric input device 514 using special keys and key sequence commands.

System 500 is also well suited to having a cursor directed by other means such as, for example, voice commands. System 500 also includes an I/O device 520 for coupling system 500 with external entities. For example, in one example, I/O device 520 is a modem for enabling wired or wireless communications between system 500 and an external network such as, but not limited to, the Internet. A more detailed discussion of the present disclosure is found below.

Referring still to FIG. 5, various other components are depicted for system 500. Specifically, when present, an operating system 522, applications 524, and data 528 are shown as typically residing in one or some combination of computer usable volatile memory 508, e.g. random access memory (RAM), and data storage unit 512. However, it is appreciated that in some examples, operating system 522 may be stored in other locations such as on a network or on a flash drive; and that further, operating system 522 may be accessed from a remote location via, for example, a coupling to the internet. In one example, the present disclosure, for example, is stored as an application 524 in memory locations within RAM 508 and memory areas within data storage unit 512. The present disclosure may be applied to one or more elements of described system 500. For example, a method of physical proximity security may be applied to operating system 522, applications 524, and/or data 528.

System 500 also includes one or more signal generating and receiving device(s) 530 coupled with bus 504 for enabling system 500 to interface with other electronic devices and computer systems. Signal generating and receiving device(s) 530 of the present example may include wired serial adaptors, modems, and network adaptors, wireless modems, and wireless network adaptors, and other such communication disclosure. The signal generating and receiving device(s) 530 may work in conjunction with one or more communication interface(s) 532 for coupling information to and/or from system 500. Communication interface 532 may include a serial port, parallel port, Universal Serial Bus (USB), Ethernet port, antenna, or other input/output interface. Communication interface 532 may physically, electrically, optically, or wirelessly (e.g. via radio frequency) couple system 500 with another device, such as a cellular telephone, radio, or computer system.

The computing system 500 is only one example of a suitable computing environment and is not intended to suggest any limitation as to the scope of use or functionality of the present disclosure. Neither should the computing environment 500 be interpreted as having any dependency or requirement relating to any one or combination of components illustrated in the example computing system 500.

The system 500 also includes the image capturing device 536 which may have all the features and capabilities of image capturing device 110 of FIG. 1. The image capturing device 536 may be a camera and system 500 is a smart phone. The system 500 also includes sensor 534 which may be built into or a separate component of system 500. The sensor 534 may have all the features and capabilities of sensor 112 of FIG. 1.

The present disclosure may be described in the general context of non-transitory computer-executable instructions, such as programs, being executed by a computer. Generally, programs include applications, routines, objects, components, data structures, etc., that perform particular tasks or implement particular abstract data types. The present disclosure may also be practiced in distributed computing environments where tasks are performed by remote processing devices that are linked through a communications network. In a distributed computing environment, programs may be located in both local and remote non-transitory computer-storage media including memory-storage devices.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A method for capturing and sharing content, comprising:
capturing content data related to a scene via an image capturing device;
capturing identifying data from a beacon via a sensor associated with the image capturing device wherein the identifying data identifies an artifact in the scene;
binding the identifying data to the content data at the image capturing device such that the artifact may be subsequently identified in the content data; and
sending the identifying data and the content data, bound together, to a content server.

2. The method as recited claim 1, wherein the binding the identifying data to the content data spawns an automated service that may occur locally or may occur after the sending to the content server.

3. The method as recited claim 1, wherein the beacon is an array of a plurality of beacons.

4. The method as recited claim 1, wherein the beacon employs a protocol and the protocol is selected from a group of protocols consisting of: Bluetooth, a radio frequency identification, WiFi, electromagnetic radiation, light, infrared, sound, barcode, and quick reference code.

5. The method as recited claim 1, wherein the content server has prior knowledge of the identifying data and is configured to automatically create a tag that textually identifies the artifact in the scene.

6. The method as recited claim 1, wherein the content data is an image or a video.

7. The method as recited claim 1, wherein the artifact is selected from the group of artifacts consisting of: a person, a physical object, a structure, a landmark, and a location.

8. The method as recited claim 1, wherein the image capturing device is selected from the group of image capturing devices consisting of: a smart phone, a device with a built in camera, a device with a separate camera, a device with the sensor built in, and a device with the sensor as a separate component.

9. A method for referencing and sharing content, comprising:
receiving content data bound with identifying data at a content server, wherein the content data is related to a scene is captured via an image capturing device and the identifying data is broadcast via a beacon in the scene and is captured via a sensor associated with the image capturing device;
creating a first tag, at the content server, based on the identifying data wherein the tag identifies an artifact associated with the beacon in the scene;
creating a second tag, at the content server, based on an analysis of the content data;
cross referencing the first tag with the second tag such that a search for the second tag by a user associated with the first tag will return results limited to content comprising both the first tag and the second tag; and
making the first tag and the second tag available for searching.

10. The method as recited claim 9, wherein the content server has prior knowledge that the identifying data identifies the artifact for the creating the first tag.

11. The method as recited claim 9, wherein the content server looks up the identifying data in a database to identify the artifact for the creating the first tag.

12. The method as recited claim 9, wherein the first tag is a text searchable identity of the artifact.

13. The method as recited claim 9, wherein the content data is a video and the analysis of the video is a frame by frame analysis of the video.

14. The method as recited claim 9, wherein the content data is an image and the analysis of the image analysis pixels of the image.

15. The method as recited claim 9, wherein the artifact is selected from the group of artifacts consisting of: a person, a physical object, a structure, a landmark, and a location.

16. The method as recited in claim 9, wherein the analysis of the content data is based on an aspect of the content data wherein the aspect is selected from the group of aspects consisting of: geographic location, facial recognition, optical character recognition, landmark recognition, a word captured in an image, and a timestamp.

17. A device for capturing and sharing content, comprising:
an image capturing device for capturing content data in a scene;
a sensor associated with the image capturing device for capturing identifying data from a beacon wherein the identifying data identifies an artifact in the scene;
a processor associated with the image capturing device for binding the identifying data to the content data at the image capturing device such that the artifact may be subsequently identified in the content data; and
a transmitter for sending the identifying data and the content data, bound together, to a content server.

18. The device as recited claim 17, wherein the beacon employs a protocol and the protocol is selected from a group of protocols consisting of: Bluetooth, a radio frequency identification, WiFi, electromagnetic radiation, light, infrared, sound, barcode, and quick reference code.

19. The device as recited claim 17, wherein the image capturing device is a camera built into the physical housing of the device.

20. The device as recited claim 17, wherein the image capturing device is a camera that is a physically separate component of the device.
